(19) United States
(12) Patent Application Publication
(10) Pub. No.: US 2023/0366048 A1
(43) Pub. Date: Nov. 16, 2023

(54) Blast furnace for ironmaking production

(71) Applicant: ArcelorMittal, Luxembeourg (LU)

(72) Inventor: Dominique SERT, Montoy Flanville (FR)

(21) Appl. No.: 18/026,003

(22) PCT Filed: Sep. 15, 2020
(86) PCT No.: PCT/IB2020/058569

§ 371 Date: Mar. 24, 2023

(51) Int. Cl. C21B 7/02; C21B 7/16

(52) U.S. Cl. CPC C21B 7/02; C21B 7/16

(57) ABSTRACT

A blast furnace for ironmaking production wherein iron ore is at least partly reduced by a reducing gas which is injected in the stack of the blast furnace. The blast furnace includes an external wall, an internal wall in contact with matters charged into the blast furnace, the internal wall including several rows of staves having a parallelepipedal shape. At least one row of staves comprises staves with a hole drilled in a least one of the corners of the parallelepipedal stave wherein an injection device may be partly inserted in.

The invention is related to a blast furnace for ironmaking production.

### BACKGROUND

In blast furnaces, the conversion of the iron-containing charge (sinter, pellets and iron ore) to cast iron is conventionally carried out by reduction of the iron oxides by a reducing gas (in particular containing CO, H2 and N2), which is formed by combustion of coke at the tuyeres located in the bottom part of the blast furnace where air preheated to a temperature between 1000° C. and 1300° C., called hot blast, is injected.

In blast furnaces, the conversion of the iron-containing charge (sinter, pellets and iron ore) to cast iron, or hot metal, is conventionally carried out by reduction of the iron oxides by a reducing gas (in particular containing CO, H2 and N2), which is formed by combustion of coke at the tuyeres located in the bottom part of the blast furnace where air preheated to a temperature between 1000° C. and 1300° C., called hot blast, is injected.

In order to increase the productivity and reduce the costs, auxiliary fuels are also injected at the tuyeres, such as coal in pulverized form, fuel oil, natural gas or other fuels, combined with oxygen enrichment of the hot blast.

The gas recovered in the upper part of the blast furnace, called top gas, mainly consists of CO, CO2, H2 and N2 in respective proportions of 20-28% v, 17-25% v, 1-5% v and 48-55% v. Despite partial use of this gas as fuel in other plants, such as power plants, blast furnace remains a significant producer of CO2.

### SUMMARY OF THE INVENTION

In view of the considerable increase in the concentration of CO2 in the atmosphere since the beginning of the last century and the subsequent greenhouse effect, it is essential to reduce emissions of CO2 where it is produced in a large quantity, and therefore in particular at blast furnaces.

For this purpose, during the last 50 years, the consumption of reducing agents in the blast furnace has been reduced by half so that, at present, in blast furnaces of conventional configuration, the consumption of carbon has reached a low limit linked to the laws of thermodynamics.

One known way of additionally reducing CO2 emissions is to reintroduce top gases that are purified of CO2 and that are rich in CO into the blast furnace, said blast furnaces are known as TGRBF (Top-Gas Recycling Blast Furnaces). The use of CO-rich gas as a reducing agent thus makes it possible to reduce the coke consumption and therefore the CO2 emissions. This injection may be done at two levels, at the classical tuyere level, in replacement of hot blast and in the reduction zone of the blast furnace, for example in the lower part of the stack ok the blast furnace.

The 1^{st} level of injection, at the tuyere level, is already existing in operational blast furnaces. The injection device may have to be adapted to take into account the changes in the composition of gas to be injected but the blast furnace structure does not need to be modified. It is not the case at the second injection level in the stack. Indeed, there is currently no injection at that level and there is so a need to modify the blast furnace to allow the insertion of the injection device at that level. This modification must have a reduced impact to not impact the durability of the components of the blast furnace.

There is so a need for a blast furnace provided with a second level of gas injection. There is moreover a need a blast furnace provided with a second level of gas injection which does not have a decreased lifetime, or which requires more regular maintenance and stoppage than standard blast furnaces with a single level of injection

The present invention provides a blast furnace comprising an external wall, an internal wall in contact with matters charged into the blast furnace and comprising several rows of staves 3 having a parallelepipedal shape, an injection device for injecting the reducing gas through an injection outlet, wherein at least one row of staves comprises staves with a hole drilled in a least one of the corners of the parallelepipedal stave wherein the injection device may be partly inserted in.

The blast furnace of the invention may also comprise the following optional characteristics considered separately or according to all possible technical combinations:
a hole is drilled in only one corner of the stave,
a first hole is drilled in one corner of a stave and a symmetrical second hole is drilled in the adjacent corner of the adjacent stave of the stave's row and the injection device is inserted in the hole formed by the first 3 and the second hole,
the number of injection devices is equal to the number of staves.
the blast furnace comprises another level of injection at the tuyere level and the blast furnace has a working height H, the reducing gas injection being performed at a height comprised between 20% and 70% of the working height H, starting from the tuyere level.
the blast furnace comprises another level of injection at the tuyere level and the blast furnace has a working height H, the reducing gas injection being performed at a height comprised between 30% and 60% of said working height H, starting from the tuyere level.

### BRIEF DESCRIPTION OF THE DRAWINGS

Other characteristics and advantages of the invention will emerge clearly from the description of it that is given below by way of an indication and which is in no way restrictive, with reference to the appended figures in which:

FIG. 1 illustrates a side view of a blast furnace with reducing gas injection in the reduction zone

FIG. 2 illustrates an upper view of the blast furnace of FIG. 1

FIG. 3 illustrates a row of staves of a blast furnace according to a first embodiment of the invention

FIG. 4 illustrates a row of staves of a blast furnace according to a second embodiment of the invention

### DETAILED DESCRIPTION

Elements in the figures are for illustration only and may not have been drawn to scale.

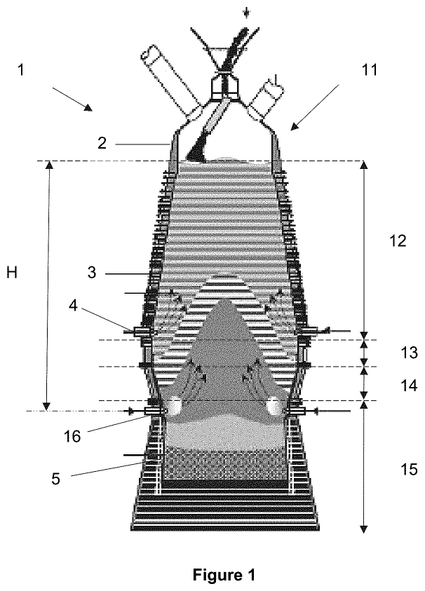

FIG. 1 is a side view of a blast furnace according to the invention. The blast furnace 1, comprises, starting from the top, a throat 11 wherein materials are loaded and gas exhaust, a stack (also called shaft) 12, a belly 13, a bosh 14 and a hearth 15. The materials loaded are mainly iron-bearing materials such as sinter, pellets or iron ore and carbon-bearing materials such as coke. The hot blast injection necessary to carbon combustion and thus iron reduction is performed by tuyeres 16 located between the bosh 14 and the hearth 15. In terms of structure, the blast furnace has an external wall, or shell 2, this shell 2 being covered, on the inside of the blast furnace, by a refractory lining and staves 3, as illustrated in FIG. 3, forming an internal wall 5. To reduce consumption of coke, which is the main carbon provider for iron reduction, it has been envisaged to inject a reducing gas in the blast furnace in addition to the hot blast. This reducing gas injection is performed in the stack of the blast furnace, preferentially in the lower part of the stack 12, for example just above the belly 13. In a preferred embodiment the reducing gas injection is performed at a distance from the classical tuyere level, comprised between 20% and 70%, preferentially between 30 and 60% of the working height H of the furnace. The working height H of a blast furnace is the distance between the level of injection of hot blast through classical tuyeres and the zero level of charging, as illustrated in FIG. 1.

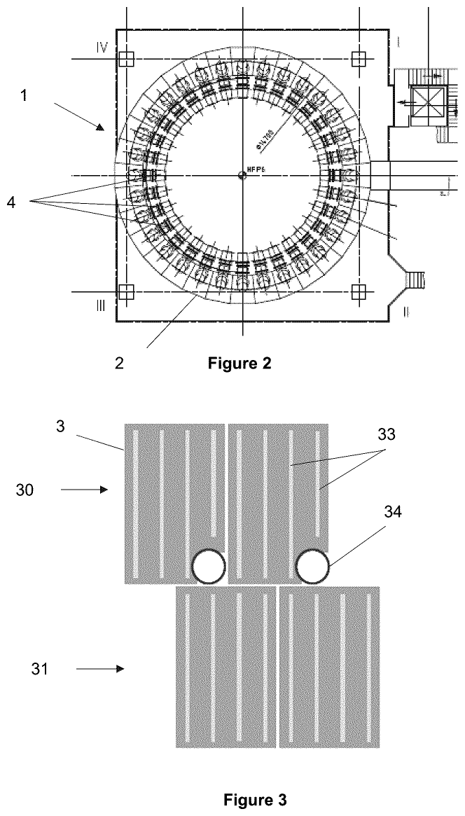

The injection is performed through several injection outlets 4 around the circumference of the furnace, as illustrated in FIG. 2, which is a top view of the blast furnace 1 at the level of injection of the reducing gas. In a preferred embodiment there are as many injection outlets as staves forming the internal wall 2. Between 200 and 700 Nm³ of reducing gas is injected per ton of hot metal in the blast furnace.

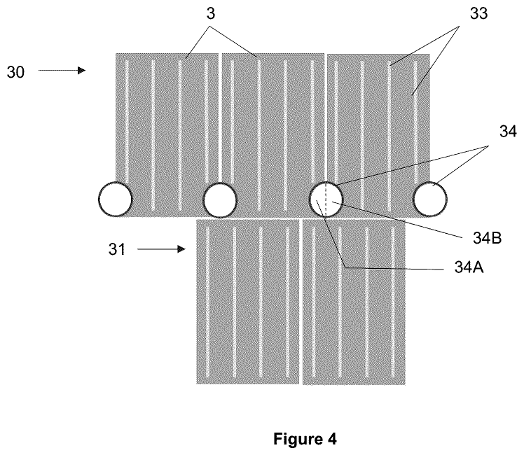

FIGS. 3 and 4 illustrate a row of staves for a blast furnace accordingly, respectively, to a first and a second embodiment of the invention. In both embodiments a first 30 and a second 31 row of staves 3 are illustrated. As illustrated these staves have a parallelepipedal shape. Those staves are usually made of copper. As the staves are installed on the internal wall of the blast furnace they are subjected to very high temperatures and are thus provided with cooling tubes 33 wherein water is circulating to cool the stave. These cooling tubes 33 are usually inserted into holes drilled along the length and into the thickness of the stave 3. According to the invention the staves of the first row 31 comprise a hole 34 drilled into at least one of their corners 35 wherein the injection device 4 may be partly inserted in. The cooling tubes 33 must be shortened at the location of the hole 34.

In a first embodiment, as illustrated in FIG. 3, several staves of the first row 30 comprise a single hole 34 in one of their bottom corners, size of the hole being dependent on the size of the injection device 4 which must be inserted in. The hole 34 is preferentially always provided in the same corner for each stave 3.

In a second embodiment, as illustrated in FIG. 4, in the first row 30, one stave is provided with a hole 34B in its left bottom corner and its adjacent stave is provided with a symmetrical hole 34A in its right bottom corner and both holes 34A and 34B are in communication so that when the two staves are installed in the blast furnace a single hole is created where the injection device 4 may be inserted.

In both embodiments, illustrations are done with bottom corners but same principle could be applied to the top corners. In a preferred embodiment, each stave is provided with at least one hole 34 so that there are as many injection devices 4 as staves and the gas is homogenously distributed around the circumference of the blast furnace.

As previously explained the staves are covering the internal wall of the blast furnace, the injection device which must be inserted into the furnace to inject the reducing gas must thus go through them. With the blast furnace according to the invention, durability of the staves is not impaired and thus no additional maintenance is required compared to classical blast furnaces. Indeed, due the thermal constraints they are subjected too, the staves may easily be deformed along the vertical axis and any weak points may be highly detrimental to the lifetime of the stave. If a stave is deteriorated it does no longer fulfil its mission of protection of the shell of the blast furnace which can, in its turn be deteriorated.

What is claimed is:

1-6. (canceled)

7. A blast furnace for ironmaking production, iron ore being at least partly reduced by a reducing gas injected in the stack of the blast furnace, the blast furnace comprising:
an external wall;
an internal wall in contact with matters charged into the blast furnace, said internal wall including a plurality of rows of staves, the staves having a parallelepipedal shape; and
at least one injector for injecting the reducing gas through an injection outlet;
at least one of the rows of staves including a hole drilled in a least one of the corners of the parallelepipedal stave, the injector at least partly inserted in the hole.

8. The blast furnace as recited in claim 7 wherein the hole is drilled in only one corner of the stave.

9. The blast furnace as recited in claim 7 wherein a first hole drilled in one corner of a first stave and a symmetrical second hole is drilled in an adjacent corner of the adjacent stave of the row of the first stave and the injector is inserted in the hole formed by the first and the second hole.

10. The blast furnace as recited in claim 7 wherein a number of injectors is equal to the number of staves.

11. The blast furnace as recited in claim 7 further comprising another level of injection at a tuyere level and the blast furnace has a working height, the reducing gas injection by the at least one injector being performed at a height between 20% and 70% of the working height, starting from the tuyere level.

12. The blast furnace as recited in claim 11 wherein the height is between 30% and 60% of the working height.
